(19) United States
(12) Patent Application Publication
(10) Pub. No.: US 2026/0139208 A1
(43) Pub. Date: May 21, 2026

(54) A PROCESS FOR ACCELERATING AGING OF SPIRITS

(71) Applicant: EtOH Spirits ApS, København (DK)

(72) Inventors: Tobias Emil Jensen, København (DK); Aleksander Byzdra, København (DK)

(21) Appl. No.: 19/120,565

(22) PCT Filed: Oct. 13, 2023
(86) PCT No.: PCT/EP2023/078561

§ 371 Date: Apr. 11, 2025

(30) Foreign Application Priority Data
Oct. 14, 2022 (DK) PA 2022 70500

(51) Int. Cl. C12H 1/22; C12G 3/07; C12H 1/14; C12H 1/16; C12H 1/18

(52) U.S. Cl. CPC C12H 1/22; C12G 3/07; C12H 1/14; C12H 1/165; C12H 1/18

(57) ABSTRACT

The present invention relates to a process for accelerating aging of spirits. In particular the invention relates to a process for producing a matured spirit comprising an extraction phase, a transformation phase and a finishing phase for obtaining a matured spirit. The process is carried out in a closed system in the presence of elevated temperature and ultrasound.

### TECHNICAL FIELD OF INVENTION

The present invention relates to a process for accelerating aging of spirits and the products obtained by the process. In particular the invention relates to a process for producing a matured spirit comprising an extraction phase, a transformation phase and a finishing phase for obtaining a matured spirit. The process is carried out in a closed system in the presence of elevated temperature, ultrasound and oxygen.

### BACKGROUND OF THE INVENTION

Traditional barrel aging of spirits is a process that requires enormous resources and patience as spirits must be stored for many years, during which the spirit slowly extracts and transforms flavour and aroma compounds from the barrel.

Long term storage of barrels is very costly, as the barrels have to be stored in large warehouses under controlled conditions to ensure optimal temperature and humidity. It is estimated that during storage, approximately 1 to 2% of the aged spirit evaporates each year through the pores of the barrels, which is a substantial economic loss. Significant amounts of wood is applied in the barrels itself and thus, from an environmental and cost perspective aging spirits in barrels impacts both the environment and the process economy in a negative direction.

Stage in barrels provides a variations in the end product. Sometimes variations may be in an order where the product cannot be sold and the producer will have to discarded it.

Hence, it would be advantageous to provide a process for accelerated ageing of spirits in a closed system, which overcomes the challenges in traditional barrel aging of spirits. It would therefore be advantageous to provide a process for accelerated aging of spirits in a more cost-effective, reliable and climate-friendly manner.

### SUMMARY OF THE INVENTION

The present invention relates to a process for accelerating aging of spirits and the products obtained by the process. In particular the invention relates to a process for producing a matured spirit comprising an extraction phase, a transformation phase and a finishing phase for obtaining a matured spirit. The process is carried out in a closed system at an elevated temperature and in the presence of ultrasound and oxygen.

Thus, an object of the present invention relates to the provision of a process for producing a matured spirit and the products obtained by the process. In particular an object of the present invention is to provide a process to force the maturation chemistry of spirits to completion faster compared to traditional barrel aging processes and to obtain a matured spirit with a flavour profile comparable to a matured spirit, produced in a slower traditional process.

Thus, an aspect of the present invention related to process for maturing an unmatured spirit, the process comprising the steps of
a) an extraction phase,
b) a transformation phase,
c) a finishing phase, and
d) obtaining a matured spirit,

wherein the process is carried out at elevated temperature and with the application of ultrasound;

wherein the extraction phase comprises contacting the unmatured spirit with wood in a reduced oxygen environment;

wherein the transformation phase comprises contacting the unmatured spirit with wood and oxygen;

wherein the finishing phase comprises contacting the unmatured spirit with oxygen and optionally wood; and

wherein the process is carried out for 21 days or fewer.

Another aspect of the present invention relates to a process for maturing an unmatured spirit, the process comprising the steps of
a) an extraction phase,
b) a transformation phase,
c) a finishing phase, and
d) obtaining a matured spirit,

wherein the extraction phase, transformation phase and finishing phase are carried out at elevated temperature and with the application of ultrasound;

wherein the extraction phase comprises contacting the unmatured spirit with wood in a reduced oxygen environment;

wherein the transformation phase comprises contacting the unmatured spirit with wood and oxygen;

wherein the finishing phase comprises contacting the unmatured spirit with oxygen and optionally wood; and

wherein the process is carried out for 21 days or fewer.

Another aspect of the present invention relates to process for maturing an unmatured spirit, the process comprising the steps of
a) an extraction phase,
b) a transformation phase,
c) a finishing phase, and
d) obtaining a matured spirit,

wherein the process is carried out at elevated temperature and with the application of ultrasound;

wherein the extraction phase comprises contacting the unmatured spirit with wood in a reduced oxygen environment;

wherein the transformation phase comprises contacting the unmatured spirit with wood and oxygen;

wherein the finishing phase comprises contacting the unmatured spirit with oxygen and optionally wood,

wherein the process is carried out for 21 days or fewer; and

wherein the process comprises diluting an extraction phase, transformation phase and/or finishing phase spirit, wherein the extraction phase, transformation phase and/or finishing phase spirit is in contact with wood during said dilution.

Another aspect of the present invention relates to a product obtained by the process as described herein.

A further aspect of the present invention relates to the use of the product as described herein as a beverage for human consumption.

A still further aspect of the present invention relates to the use of the process for maturing a spirit as described herein.

### BRIEF DESCRIPTION OF FIGURE

FIG. 1. Flow-chart of the method described herein, comprising an extraction phase, a transformation phase and a finishing phase.

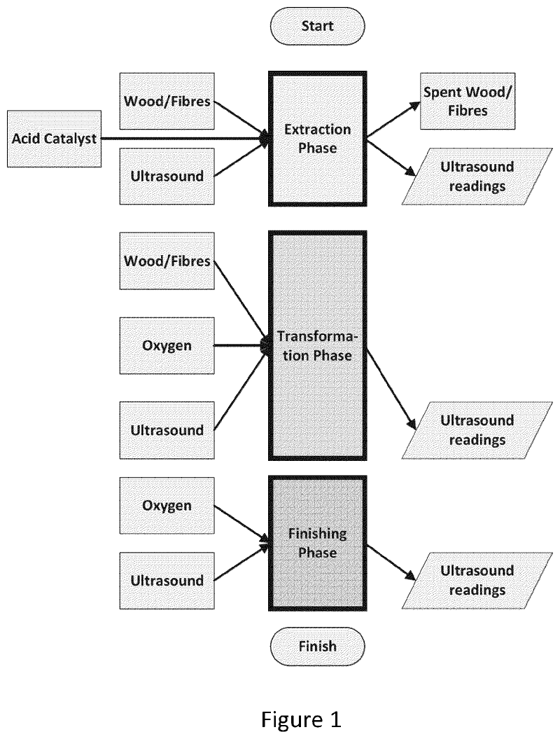

FIG. 2a-c. Comparative data showing the effect of ultrasound on the abundance of flavour compounds.

FIG. 3a-d. Comparative data showing the difference in extraction efficiency of different flavour compounds.

FIG. 4a-c. Comparative data showing the effect of a UV or visible on the abundance of flavour compounds.

### DETAILED DESCRIPTION OF THE INVENTION

The inventors of the present invention have developed a method for aging a spirit in a closed system so as to reduce evaporation of spirits and wherein maturation can be accelerated by applying a series of unique steps including ultrasound, elevated temperatures, the addition of oxygen and esterification catalysts.

Further, accelerated aging of spirits by use of the method described herein can lead to new unique flavours that are highly controlled and reproduceable.

### Definitions

Prior to outlining the present invention in more detail, a set of terms and conventions is first defined:

### Process

In the present context, the “process of the disclosure” relates to a method of accelerating the aging of a spirit. The process comprises an extraction phase, a transformation phase and a finishing phase wherein each of the three phases are carried out at elevated temperature in the presence of ultrasound.

The process of the of the disclosure may also comprise pre-processing or post-processing steps wherein pre-processing steps are any steps carried out before initiation of the extraction phase and post-processing steps are any steps carried out after completion of the finishing phase as defined herein.

“Process of the disclosure”, “process of the invention” or “process” are used herein interchangeably throughout this disclosure and refer to a process for accelerating the aging of a spirit. The term “process” in the context of the disclosure includes any optional pre- and/or post-processing steps, and any optional pre-treatment steps.

### Accelerating Aging

In the present context, the term “accelerated aging” refers to a process where a spirit beverage has been subjected to an aging process, wherein the aging process has been manipulated to be accelerated, and wherein the aging process last for maximum 3 weeks.

### Spirit

In the present context, the term “spirit” is to be understood as a liquid that has been distilled and where the ethanol has been in the gas phase.

### Aged Spirit/Matured Spirit

In the present context, the terms “aged spirit(s)” or “matured spirit(s)” are used interchangeably and refer to a spirit beverage that has an aged flavour-profile, obtained through an aging or maturation process, and wherein at least one of the following maturation congeners are present in the aged spirit: gallic acid, furfural, syringic acid, syringaldehyde, vanillin, vanillic acid, eugenol, phenylethyl alcohol, phenethyl acetate, cis-Whisky lactone, benzaldehyde and any combination thereof.

### Wood Congeners and Maturation Congeners

In the present context, the terms “wood congeners” and “maturation congeners” refer to flavour and colour compounds formed in alcohol during pre-distillation fermentation and exposure to wood during aging and maturation. These congeners can be the following, but are not limited to gallic acid, furfural, syringic acid, syringaldehyde, vanillin, vanillic acid, eugenol, phenylethyl alcohol, cis-Whisky lactone, benzaldehyde and any combination thereof. The congeners may be measured using Gas Chromatography mass Spectrometry (GCMS).

### Esterification

In the present context, the term “esterification” refers to a chemical condensation reaction between an alcohol and a carboxylic acid to form an ester.

### Cubes or Cylinders

In the present context, the terms “cubes” and “cylinders” refers to the shape of wood, wherein at least one dimension is less than 2 cm, and the total volume of the cube or cylinder is less than 30 cm³ The cube or cylinder may be largely cube or cylinder-shaped, however also contemplated are spheres, cuboids, rods or irregular shapes amongst others.

### The European Brewing Convention (EBC) Scale

In the present context, the terms “The European Brewing Convention (EBC) scale” refers to a method for measuring colour grading in beer, malt solutions and similar coloured liquids.

### Unmatured Spirit

In the present context, the term “unmatured spirit” refers to a distilled alcohol product suitable for human consumption. In particular, an unmatured spirit is a distilled spirit that has not been matured by the process of the present invention. The phrase “unmatured spirit” may therefore be used to describe the a spirit before and during and after each of the steps of the process apart from the spirit obtained after the finishing phase. The spirit obtained after the finishing phase is a matured spirit.

The process of the invention may be used in conjugation with any other maturation process. For example, an unmatured spirit may already have been matured according to a traditional maturation process, or any other maturation process.

### Reduced Oxygen Environment

In the present context, the term “reduced oxygen” or “reduced oxygen environment” refers to an environment (for example a reactor) wherein the oxygen concentration is low. It is important that the extraction phase of the disclosure is carried out in a reduced oxygen environment. Whilst the extraction phase is not highly sensitive to oxygen, a high oxygen content may have an adverse effect on the taste and aroma of the matured spirit that results the process. In preferred embodiments, the reactor in which the process is carried out is a sealed container that is filled with liquid (unmatured spirit). That is, there is no headspace between the top of the reactor and the top level of the liquid. In such an embodiment, the only oxygen present in the reactor is the oxygen dissolved in the liquid phase. Such a concentration of oxygen is low enough that the extraction phase is not negatively affected by the presence of the dissolved oxygen, and no intervention is required in order to provide a reduced oxygen environment. In such embodiments, the amount of oxygen dissolved in the liquid of the extraction phase is less than 200 ppm, such as less than 100 ppm, less than 50 ppm or less than 20 ppm. In embodiments wherein the reactor is not completely filled with liquid, oxygen may be present in the headspace between the top of the liquid and the top of the reactor. This may be a significant amount of oxygen if the headspace is large and the space is filled with air. At around 25° C., the partial pressure of oxygen in a headspace filled with air is around 0.2 bar (assuming that air comprises around 20% oxygen). This amount of oxygen may have an adverse effect on the extraction phase. In an embodiment wherein the headspace is filled with air, intervention may be needed to reduce the oxygen partial pressure such that the extraction phase can be carried out in a reduced oxygen environment. The amount of oxygen may be reduced by vacuum extraction of the air in the headspace, or it may be replaced with an inert gas, for instance nitrogen, before the extraction phase is carried out. It will be appreciate that if vacuum extraction is used as the method by which the oxygen partial pressure is reduced, care may preferably be taken to ensure that desired volatile compounds (such as ethanol) as not reduced to an undesirable degree. Preferably, the oxygen partial pressure of the headspace during the extraction phase is less than 0.1 bar, such as less than 0.05 bar, less than 0.03 bar, or less than 0.1 bar. Preferably, the partial pressure of the oxygen in the headspace of the reactor is less than 0.1 bar. A “reduced oxygen environment” according to the present disclosure is there an environment wherein the amount of oxygen dissolved in the liquid phase is less than 200 ppm, and the partial pressure of oxygen in the headspace (if present) is less than 0.1 bar.

### Volatile Acids/Volatile Compounds

In the present context, the terms “volatile acids” and “volatile compounds” refers to acids or compounds that influence the flavour-profile and mouthfeel of matured/aged spirits.

### Circulating Flow/Circulating Flow Rate

In the present context, the terms “circulating flow” and “circulating flow rate” are to be understood as a mixing rate. The object of the circulating flow rate is to provide sufficient motion and contact between wood and spirit.

Alternative methods such as agitation, churning or shaking may be used to achieve the same effect.

### Pre-Treatment

In the present context, the term “pre-treatment” is to be understood as a treatment of the wood prior to being used in the process as describes herein for producing a matured spirit.

### Iron (III)

In the present context, and “iron (III)” or “Fe(III)” compound is a compound in which iron is present in the +3 oxidation state. The term iron (III) may be used interchangeably with the term “ferric cation”.

Dilution Step Carried Out on a Spirit which is in Contact with Wood

In the present context, “dilution” or “dilution step” refers to adding water to a spirit, wherein the spirit is in contact with wood. In relation to “dilution” or “dilution step” carried out on a spirit in contact with wood, the spirit is to be understood as a spirit selected from the group consisting of an unmatured spirit, an extraction spirit, a transformation phase spirit, a finishing phase spirit, a matured spirit and combinations thereof.

The water used for dilution is preferably purified water such as water that has been chemically or physically purified. Examples of suitable purification methods are physical filtration with active carbon, sand filter, or chemical filtration such as reverse osmosis, flocculation or the use of ultraviolet light. Preferably the water used for dilution is reverse osmosis water.

One or more dilution(s) or dilution step(s) may be carried out at any phase of the process, or as a pre- or post-processing step on a spirit in contact with wood. Preferably, at least one dilution or one dilution step is carried out on a spirit in contact with wood before obtaining a matured spirit. In an embodiment the process comprises a dilution of the extraction phase spirit and wherein the extraction phase spirit is in contact with wood. In another embodiment the process comprises a dilution of the transformation phase spirit and wherein the transformation phase spirit is in contact with wood. In an embodiment the process comprises a dilution of the finishing phase spirit, wherein the finishing phase spirit is in contact with wood and before the finishing phase is terminated.

Dilution Step Carried Out on a Matured Spirit not in Contact with Wood

When required, the matured spirit may also be diluted after the process is finished in order to obtain the desired ethanol content (ABV) e.g., the ABV of the matured spirit ready for consumption. It is to be understood that such dilution step is to be carried out on a matured spirit that is not in contact wood.

The water used for a dilution step carried out on a matured spirit not in contact with wood is preferably purified water such as water that has been chemically or physically purified. Examples of suitable purification methods are physical filtration with active carbon, sand filter, or chemical filtration such as reverse osmosis, flocculation or the use of ultraviolet light. Preferably the water used for dilution is reverse osmosis water.

### Post-Processing

The process of the invention may comprise post-processing steps. In the present context, “post-processing” is to be understood as any processing step carried out on a matured spirit i.e., the spirit after completion of the extraction, transformation and finishing phases.

Post-processing steps may be used to fine-tune the flavour profile and is surprisingly effective at enhancing or reducing the concentration of flavour compounds.

Particularly advantageous post-processing steps include UV or visible light treatment or addition of acid components such as volatile acids or acid catalysts.

Post-processing steps may be performed immediately after obtaining a matured spirit, or performed after the matured spirit has been stored and/or transported to a second location. This allows for the final flavour profile of the product to be selected at a later stage, depending on requirements.

In some embodiments, the post-processing step is performed on only part of a batch of mature spirit. This allows for the production of different end-products, with different flavour profiles, from the same batch of matured spirit.

In some embodiments, more than one post-processing step is performed, for instance addition of a first acid catalyst and irradiation with UV light. Combining and/or staggering post-processing steps provides the opportunity to further customize the flavour profile.

Alternatively, the post-processing step may be used to counteract the effect of over—or under-extraction. For example, if the extraction/transformation/finishing phase over-extracts a particular compound, a complimentary post-processing step may be carried out to reduce the abundance of said over-extracted compound.

The inventors of the present invention surprisingly succeeded in developing a process for producing a matured spirit in an accelerated manner with a flavour-profile comparable to a matured spirit produced by traditional barrel aging process.

An aspect of the present invention relates to a process for maturing an unmatured spirit, the process comprising the steps of
a) an extraction phase,
b) a transformation phase,
c) a finishing phase, and
d) obtaining a matured spirit,

wherein the process is carried out at elevated temperature and with the application of ultrasound;
wherein the extraction phase comprises contacting the unmatured spirit with wood in a reduced oxygen environment;
wherein the transformation phase comprises contacting the unmatured spirit with wood and oxygen;

wherein the finishing phase comprises contacting the unmatured spirit with oxygen and optionally wood; and

wherein the process is carried out for 21 days or fewer.

Another aspect of the present invention relates to a process for maturing an unmatured spirit, the process comprising the steps of
a) an extraction phase,
b) a transformation phase,
c) a finishing phase, and
d) obtaining a matured spirit,

wherein the extraction phase, transformation phase and finishing phase are carried out at elevated temperature and with the application of ultrasound;

wherein the extraction phase comprises contacting the unmatured spirit with wood in a reduced oxygen environment;

wherein the transformation phase comprises contacting the unmatured spirit with wood and oxygen;

wherein the finishing phase comprises contacting the unmatured spirit with oxygen and optionally wood; and

wherein the process is carried out for 21 days or fewer.

Yet another aspect of the present invention relates to process for maturing an unmatured spirit, the process comprising the steps of
a) an extraction phase,
b) a transformation phase,
c) a finishing phase, and
d) obtaining a matured spirit,

wherein the process is carried out at elevated temperature and with the application of ultrasound;

wherein the extraction phase comprises contacting the unmatured spirit with wood in a reduced oxygen environment;

wherein the transformation phase comprises contacting the unmatured spirit with wood and oxygen;

wherein the finishing phase comprises contacting the unmatured spirit with oxygen and optionally wood,

wherein the process is carried out for 21 days or fewer; and

wherein the process comprises diluting an extraction phase, transformation phase and/or finishing phase spirit, wherein the extraction phase, transformation phase and/or finishing phase spirit is in contact with wood during said dilution.

The application of a series of unique steps that makes the process of the present invention highly controllable and makes it possible to reproduce nearly identical products if needed.

An embodiment of the present invention relates to the process as described herein, wherein the steps of the process in carried out in the defined order.

The extraction phase, transformation phase and finishing phase are all carried out at elevated temperature and with the application of ultrasound. Pre- and post-processing steps may also be carried out at elevated temperature and with the application of ultrasound.

In the present context, “extraction phase” is to be understood as a period of time wherein an unmatured spirit and wood are in contact at an elevated temperature and in the presence of ultrasound. It is important that the extraction phase is carried out in a reduced oxygen environment—i.e., an environment substantially free from oxygen. For example, the extraction phase may be carried out in a sealed vessel wherein the oxygen content of the gas phase in the sealed vessel is less than 100 ppm.

Optionally, oxygen dissolved in the unmatured spirit may also be removed via vacuum extraction before the extraction phase is initiated.

In the present context, “transformation phase” is to be understood as a period of time wherein an extraction phase spirit, wood and oxygen are in contact at elevated temperature and in the presence of ultrasound. An extraction phase spirit is an unmatured spirit that has been processed according to the extraction phase step.

In the present context, “finishing phase” is to be understood as a period of time wherein a transformed phase spirit, oxygen and water are in contact at elevated temperature in the presence of ultrasound, and wherein at least one of the following maturation congeners are present in the aged spirit: gallic acid, furfural, syringic acid, syringaldehyde, vanillin, vanillic acid, eugenol, phenylethyl alcohol, cis-Whisky lactone, benzaldehyde and any combination thereof. A finishing phase spirit is an unmatured spirit that has been processed according to the extraction phase and transformation phase steps.

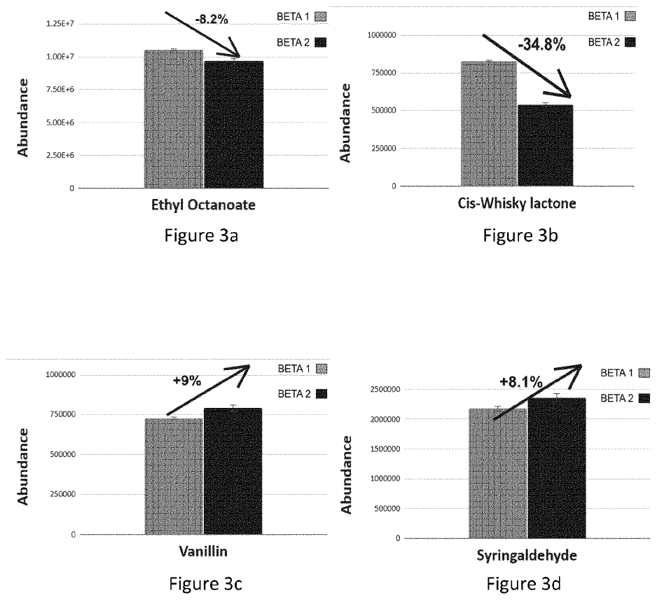

Surprisingly, performing the process of the invention with different ethanol contents has been shown to provide particularly beneficial results. Without wishing to be bound by theory, it is considered that different flavour compounds are extracted at different rates depending on the water/ethanol ratio of the sprit that is in contact with wood. For example, compounds such as ethyl octanoate and cis-whisky lactone are extracted more efficiently at higher ethanol content, and compounds such as vanillin and syringaldehyde are extracted more efficiently at a lower ethanol content (see Example 2 and FIG. 3a-3d).

Varying the ethanol content of any phase wherein a spirit and wood are in contact (i.e., a phase where extraction may occur) allows for customization of the flavour profile, facilitating the production of a wide range of matured spirits.

Accordingly, the process may comprise at least one dilution step, preferably carried out part-way through a phase wherein a spirit is in contact with wood.

The dilution step wherein a spirit is in contact with wood may comprise adding 1-10% v/v of water to the spirit. For example, the dilution step may comprise adding 1-10% v/v water, such as 1-5% v/v water, 1-3% v/v water, preferably 2% v/v water.

Preferably, the dilution step wherein a spirit is in contact with wood, results in a change in ethanol content of from 50-75% v/v, such as 55-70% v/v such as 58-68% v/v, such as 60-65% v/v, preferably 61-64% v/v and more preferably 62-63% v/v to an ethanol content in the range of 35-65% v/v, such as 40-60% v/v, such as 45-60% v/v, e.g. 45-55% v/v, preferably 48-55% v/v and more preferably 50-53% v/v.

In an embodiment, the spirit in contact with wood has an ethanol content of 60-65% v/v, such as 61-64% v/v, e.g., 62-63% v/v 40-54% v/v before dilution and an ethanol content of 42-52% v/v, e.g., 44-50% v/v, such as 46-48% v/v after dilution.

In some embodiments, the ethanol content of the spirit after dilution is the desired ethanol content ready for consumption and no further dilution of the spirit after removal of the wood is required.

For processes comprising a dilution step wherein a spirit is in contact with wood, the remaining process steps may also be carried out on the diluted spirit, or the spirit may be reconcentrated before continuing the process.

Preferably, the dilution step wherein a spirit is in contact with wood is carried out part-way through a phase, for instance around half-way through a phase.

In an embodiment, the extraction phase comprises a dilution step wherein the spirit is in contact with wood, preferably wherein the dilution step is carried out part-way through the extraction phase.

In an embodiment, the transformation phase comprises a dilution step wherein the spirit in contact with wood, preferably wherein the dilution step is carried out part-way through the transformation phase.

In an embodiment, the finishing phase comprises a dilution step wherein the spirit is in contact with wood, preferably wherein the dilution step is carried out part-way through the finishing phase, and wherein there is wood present during the finishing phase.

Preferably, the dilution step wherein a spirit is in contact with wood results in a spirit with an ethanol content of 50-53% v/V.

In some embodiments, the extraction phase, transformation phase and/or finishing phase comprise a dilution step wherein a spirit is in contact with wood, wherein preferably the dilution step is carried out part-way through the extraction, transformation or finishing phases respectively.

In some embodiments, the dilution step wherein a spirit is in contact with wood comprises multiple dilutions i.e. a first and a second addition of water. Where multiple dilutions of a spirit in contact with wood are carried out as part of the dilution step, there is preferably at least a 2-96 hours delay between the end of the first addition and the start of the second addition, such that the ethanol content is decreased step-wise. In a preferred embodiment there is at least a 24 hours delay between the end of one dilution and the start of another dilution.

In an embodiment, the dilution step wherein a spirit is in contact with wood comprises adding 1-10% v/v water, waiting at least 2 hours, and adding more water.

Preferably, such dilution steps wherein a spirit is in contact with wood comprises a delay of 2-96 hours between additions of water. For instance, a delay of 2-96 hours, e.g., 2-72 hours, 2-48 hours, 2-24 hours or 2-12 hours between additions of water.

In an embodiment, the dilution step wherein a spirit is in contact with wood comprises multiple additions of water wherein preferably each addition comprises adding 1-10% v/v water, such as 1-5% v/v water, 1-3% v/v water, preferably 2% v/v water.

Preferably, the dilution step wherein a spirit is in contact with wood comprises adding 2% v/v water, waiting at least 2 hours and adding a further 2% v/v water.

One advantage of using multiple dilutions wherein a spirit is in contact with wood is that step-wise extraction of different flavour compounds can be achieved allowing for fine-tuning of the flavour profile.

An embodiment of the present invention relates to the process as described herein, wherein the extraction phase comprises contacting an unmatured spirit with wood.

Another embodiment of the present invention relates to the process as described herein, wherein the unmatured spirit is selected from the group consisting of sugar cane spirits, grain spirits, malt spirit, potato spirit, fruit spirits, agave spirits and any combination thereof.

Further, an embodiment of the present invention relates to the process as described herein, wherein the unmatured spirit is selected from the group consisting of rum, tequila, mescal, whisky, whiskey, vodka, eau de vie, aquavit, bierbrand, beer, wine brandy, gin, sake, soju, baidju and any combination thereof.

In an embodiment, the unmatured spirit is rum.

In an embodiment, the unmatured spirit is tequila.

In an embodiment, the unmatured spirit is mescal.

In an embodiment, the unmatured spirit is whisky.

In an embodiment, the unmatured spirit is vodka.

In an embodiment, the unmatured spirit is eau de vie.

In an embodiment, the unmatured spirit is aquavit.

In an embodiment, the unmatured spirit is bierbrand.

In an embodiment, the unmatured spirit is beer.

In an embodiment, the unmatured spirit is wine.

In an embodiment, the unmatured spirit is brandy.

In an embodiment, the unmatured spirit is gin.

In an embodiment, the unmatured spirit is sake.

In an embodiment, the unmatured spirit is soju.

In an embodiment, the unmatured spirit is baidju.

Further, an embodiment of the present invention relates to the process as described herein, wherein the unmatured spirit has an ethanol content of 60 to 65% v/v, such as 61 to 64% v/v, e.g., 62-63% v/v.

The ethanol content of the unmatured spirit, or any other spirit for that matter, may be determined with an alcohol hydrometer. Hydrometers are suitable for determining, by density/gravity, the percentage of ethanol (by volume) in a liquid that is otherwise water. The temperature of the liquid may affect the hydrometer measurement and thus should be taken in to account when determining the ethanol content of the unmatured spirit. In respect of the present invention the percentage of ethanol is determined at 20° C.

In the present invention, elevated temperatures are used to accelerate the degradation of wood, such that wood congeners, soluble phenolics, colour compounds and ellagic acids are released to the spirit. An embodiment of the present invention relates to the process as described herein, wherein the elevated temperature is from 50° C. to 75° C., such as 52° C. to 73° C., e.g., 54° C. to 70° C., such as 56° C. to 68° C., e.g. 58° C. to 66° C., such as 60° C. to 64° C. and preferably 64° C. to 66° C. A further embodiment of the present invention relates to the process as described herein, wherein the preferred elevated temperature is 65° C.

Ultrasound waves are widely used in the food industry for extraction, drying, crystallisation, filtration, defoaming, homogenization and as a preservation technique. The principle aim of using ultrasound is to reduce the processing time, save energy and improve the shelf life and quality of food products. Thus, it could be advantageous to use ultrasound waves in the process of accelerating aging of spirits, as it can significantly reduce production time compared to traditional barrel aging. In the closed system spirit aging method of the invention, ultrasound is applied for at least part of the aging process in order to accelerate maturation. In the present invention, ultrasound is used to accelerate the extraction of wood into the spirit to obtain an extract of wood congeners. The ultrasound waves can break the cell walls of the wood thus allowing the spirit to penetrate the wood more easily. Further, ultrasound waves cause periodic changes in air pressure and the energy is transmitted through the spirit by inducing vibrations in the molecules through which the ultrasound wave travels.

Thus, another embodiment of the present invention relates to the process as described herein, wherein the ultrasound is applied at a frequency greater than 20.000 Hz.

Another embodiment of the present invention relates to the process as described herein, wherein the ultrasound is applied at a power of at least 1 Watt/liter. A further embodiment of the present invention relates to the process as described herein, wherein the ultrasound is applied at a power between 2 to 5 Watts/liter.

In the present context “ultrasound” is to be understood as sound waves with frequencies in the range 20.000 Hz to 22.000 Hz.

Another embodiment of the present invention relates to the process as described herein, wherein the ultrasound is applied in cycles.

In the present context “cycles” is to be understood as a series of repeated events that takes place for a period of time. In this context, one cycle can be from 5 to 12 hours.

A further embodiment of the present invention relates to the process as described herein, wherein the ultrasound is applied in cycles of 8 to 12 hours for at least 8 days.

Another embodiment of the present invention relates to the process as described herein, wherein the ultrasound is applied using a cascatrode.

In the present context, to evaluate the maturation of the spirit during the extraction phase, the European Brewing Convention (EBC) scale is used to measure the colour shift of the spirit and to determine when the extraction phase should end and the transformation phase should begin.

Yet another embodiment of the present invention relates to the process as described herein, wherein the extraction phase is terminated when the colour of the extraction phase spirit is measured on the European Brewing Convention (EBC) scale in the range of 2 to 8 EBC and/or when 4 days have elapsed from initiation of the extraction phase.

In an embodiment a additional round of extraction can be performed to increase the EBC number—i.e., by contacting an unmatured spirit with new wood. The new wood may be the wood as described above.

Various inorganic acids and/or organic acids can be used as catalysts for esterification. Esterification is a chemical reaction between alcohol and carboxylic acids to form esters, which are flavour and aromatic compounds that contributes to the flavour profile in matured spirits.

Additionally, organic acids may decrease the partition coefficient of solutes such as large organic molecules, in an ethanol/water emulsion. The partition coefficient is a measure of the distribution of a solute between the two phases of the emulsion. A low partition coefficient indicates an increased solubility of a solute in the water phase of an emulsion. For example, the partition coefficient of ethyl decanoate—a large organic molecule that is a key aroma compound in aged spirits—is reduced in a water/ethanol emulsion when an organic acid is present. This means that ethyl decanoate is more soluble in the water phase when an acid is present, and thus the concentration of ethyl decanoate in the water phase will be higher than for emulsions wherein there is no organic acid present. Moreover, the addition of an organic acid may improve the sensory impact of the aged spirits. Immature aroma compounds often have a high volatility and thus occupy the headspace about the liquid. This results in an immature aroma and can vastly influence flavour perception. Typically, further processing steps are used in order to remove these immature aroma compounds which is costly and may slow production rates. Fortunately, immature aroma compounds tend to have a similar hydrophobicity to ethyl decanoate. Therefore, in the presence of an organic acid, the partition coefficient of the immature aroma compounds may also be decreased such that their solubility in the water fraction is increased. The immature aroma compounds may therefore be “trapped” in the spirit and prevented from volatilizing. Surprisingly, this masks the immature flavour and aroma and may result in an ages spirit with an improved flavour-profile and mouthfeel.

Furthermore, inorganic acids can increase the rate of ester production in an accelerated spirit. It is beneficial to use low concentration of inorganic acids to catalyse esterification reaction in accelerated spirits, as it will allow for using both organic and inorganic acids to manipulate the spirit without decreasing the pH, which is an important parameter in the overall taste of the spirit.

An embodiment of the present invention relates to the process as described herein, wherein the extraction phase comprises a step of providing a first acid catalyst. Another embodiment of the present invention relates to the process as described herein, wherein the first acid catalyst is an inorganic acid or an organic acid.

Still, another embodiment of the present invention relates to the process as described herein, wherein the first acid catalyst is selected from the group consisting of hydrochloric acid, citric acid, acetic acid, malic acid, tartaric acid and any combinations thereof.

A further embodiment of the present invention relates to the process as described herein, wherein the first acid catalyst is hydrochloric acid.

Thus, an embodiment of the present invention relates to the process as described herein, wherein the concentration of hydrochloric acid is in the range of 0.02 mMol/liter to 0.2 Mmol/liter in the extraction phase spirit and/or in the matured spirit.

Another embodiment of the present disclosure relates to a process wherein either the extraction phase, transformation phase or finishing phase comprises the step of providing a first acid catalyst.

In an embodiment, the process comprises a post-processing step, wherein the post-processing step comprises providing a first acid catalyst. In one embodiment the first acid catalyst is an inorganic acid or an organic acid. In another embodiment the first acid catalyst is selected from the group consisting of hydrochloric acid, citric acid, acetic acid, malic acid, tartaric acid and any combinations thereof. In an embodiment of the present invention the concentration of acid the post-processed step is in the range of 0.1 g/L to 1.5 g/L in the matured spirit, for example 0.33 g/L to 1 g/L.

The wood is added into the spirit in intervals in a constant circulating system, provided by the closed production system. In this way, the closed system simulates the conditions in a traditionally barrel aging process.

An embodiment of the present invention relates to the process as described herein, wherein the transformation phase further comprises a step of adding wood. Oxygen increases the oxidation of wood and facilitates the smoothness in aged spirits. In the context of the disclosure, smoothness refers to the mouthfeel and/or viscosity of the spirit, for example due to the absence of astringent notes. In traditional aging processes, the wood of the barrel is oxidised over time which imparts flavour. The taste and aroma compounds in the spirit are also oxidised during the process, and may give the maturated spirit its distinctive flavour. Both the amount of oxygen, the rate of oxygen supply may affect the aging process and thus the taste of the matured spirit. In a traditional aging process, oxygen passes through the pores in the wood barrel, and through small holes between the joints in the wood of the barrel. A spirit aged in a traditional process is therefore in constant contact with oxygen throughout the maturation process.

In order to replicate the traditional aging process in a closed system, it may be advantageous to provide oxygen, and in particular a constant stream of oxygen. The benefit of a closed system for aging is that the amount of oxygen and the rate of the oxygen can be controlled more accurately than for a traditional barrel aging system. In the closed spirit aging method of the invention, oxygen is provided for at least part of the process in order to ensure that oxidation can occur.

An embodiment of the present invention relates to the process as described herein, wherein the oxygen is provided at 0.01 to 0.1 L per minute per liter of transformation phase spirit for at least 5 hours.

An embodiment of the present invention relates to the process as described herein, wherein the oxygen is preferably provided at 0.01 L per minute per liter of transformation phase spirit for at least 5 hours.

An embodiment of the present invention relates to the process as described herein, wherein the oxygen is provided in cycles.

An embodiment of the present invention relates to the process as described herein, wherein the oxygen is provided in at least 5 cycles.

Managing flow rate and temperature are essential aspects for producing a matured spirit. In the 1700's it was discovered that transporting bourbon by boat vastly improved the bourbon's flavour, likely due to the constant motion accelerating the aging process. For example, the 4-year-old ocean aged bourbon of the time was darker than 30-year-old classic aged bourbon. Ocean aging method combines a constant flow rate of the spirit in the barrel as well as higher fluctuations of the temperature due to tropical locations. As the temperature increases, the spirit may seep in to new pores in the barrel, and thus a higher contact area of wood and spirit is achieved. On the other hand, as temperature decreases, the pores in the wood contract and expel the alcohol. During this process, a water-ethanol emulsion is formed which slowly increases the concentration of wood congeners every time the alcohol is expelled from the pores.

In the closed spirit aging method of the invention, wood cubes or cylinders are used. In this way, the traditional ocean barrel aging of spirits can be simulated by introducing spirit to wood cubes or cylinders at intervals whilst the spirit is in constant motion, for example the spirit and wood pieces are in a constantly circulating system. The flow rate of the circulating system is optimised to provide sufficient contact time between wood and spirit.

Furthermore, the constant spirit aging method of the invention is carried out at elevated temperature. High temperatures facilitate the degradation of cell walls in the wood, and as consequence release a higher amount of soluble phenolics, colour compounds and ellagic acid.

The flow rate used in the present invention may be optimised to provide sufficient motion and contact between wood and spirit through a circulating flow. Adequate contact time between wood and spirit is key to achieve a spirit with a matured flavour-profile.

An embodiment of the present invention relates to the process as described herein, wherein a constant circulating flow rate is provided.

An embodiment of the present invention relates to the process as described herein, wherein the circulating flow rate is provided in the range between 1 to 15 mm/s. An embodiment of the present invention relates to the process as described herein, wherein the preferred circulating flow rate is 2 mm/s.

An embodiment of the present invention relates to the process as described herein, wherein the circulating flow rate is provided in the range between 1 to 60 rpm. An embodiment of the present invention relates to the process as described herein, wherein the preferred circulating flow rate is provided in the range between 25 to 35 rpm.

In the present context, to evaluate the maturation of the spirit during the transformation phase, the European Brewing Convention (EBC) scale is used to measure the colour shift of the spirit and to determine when the transformation phase ends.

An embodiment of the present invention relates to the process as described herein, wherein the transformation phase is terminated when the colour of the transformation phase spirit is measured on the European Brewing Convention (EBC) scale in the range of 4 to 12 EBC and/or after 5 days from the initiation of the transformation phase spirit.

Various types of wood can be used in the present invention, depending on the desired flavour-profile of the matures spirit. In the present invention, both new wood and re-used wood from spirits, wine or beer barrels can be used. The shape and volume of the wood will have an impact the extraction rate and the extraction efficiency. The higher the surface area of the wood, the higher the contact area between the wood and the spirit which may lead to an increased extraction efficiency. Ideally, the total volume of the wood pieces is low therefore. It may also be beneficial to provide wood pieces with one very small dimension, for example less than 2 cm, less than 1 cm, or less than 0.5 cm. This may decrease soaking time, and may allow for faster or more efficient spirit penetration. This results in faster or more efficient access into the internal volume of the wood, and thus the contact area of the wood and the spirit is maximized. This may also have the added benefit of minimizing wood waste by ensuring that the total volume of the wood is used during the aging process.

An embodiment of the present invention relates to the process as described herein, wherein the wood is selected from the group consisting of oak, cedar, birch, beech, acacia, maple, hickory, redwood, walnut chestnut, apple, pecan, cherry, plum and any combinations thereof.

Another embodiment of the present invention relates to the process as described herein, wherein the wood is new wood and/or re-used wood from spirits, wine or beer barrels.

Yet, another embodiment of the present invention relates to the process as described herein, wherein the wood is cube or cylinder shaped. Further, an embodiment of the present invention relates to the process as described herein, wherein the wood is in pieces and the pieces have at least one dimension that is 2 cm or less.

Still, another embodiment of the present invention relates to the process as described herein, wherein the wood has a surface area of 10 to 30 cm².

Another embodiment of the present invention relates to the process as described herein, wherein the wood has a preferred surface area of 16 cm².

Pre-treating the wood is a means of controlling the outcome of the flavour-profile in the matured spirit. Various pre-treatment steps can therefore be applied to the wood prior to use in the process of the present invention.

An embodiment of the present invention relates to the process as described herein, wherein the wood is pre-treated.

Another embodiment of the present invention relates to the process as described herein, wherein the pre-treatment comprises a first step of soaking the wood in water, wine, spirits with varying degrees of fermentation and combinations thereof.

A further embodiment of the present invention relates to the process as described herein, wherein the pre-treatment further comprises a step of soaking the wood in water comprising enzymes sugars, acids, tannins, polyphenols and combinations thereof.

Yet, another embodiment of the present invention relates to the process as described herein, wherein the pre-treatment comprises a final step of toasting, charring, polishing, sanding and combinations thereof.

An embodiment of the present invention relates to the process as described herein, wherein the wood to spirit ratio in g/L in the extraction phase and transformation phase is between 2 to 20 g/L. An embodiment of the present invention relates to the process as described herein, wherein the preferred wood to spirit ratio in g/L in the extraction phase and transformation phase is 5 g/L.

Another embodiment of the present invention relates to the process as described herein, wherein the finishing phase comprises providing oxygen to the transformation phase spirit. The alcohol strength of the spirit is decreased during the finishing phase by adding water. By decreasing the alcohol strength before the finishing phase is terminated, the conditions in a traditional barrel aging process are mimicked, which leads to a greater extraction of water-soluble wood components such as tannins, glycerol and sugars. These water-soluble wood components add flavour to the spirit. In the present context, the finishing phase starts when water is added to the transformation phase spirit together with oxygen, elevated temperature and ultrasound.

Thus, an embodiment of the present invention relates to the process as described herein, wherein the finishing phase further comprises a step of decreasing the alcohol content by adding water.

An embodiment of the present invention relates to the process as described herein, wherein the water is reverse osmosis water.

Another embodiment of the present invention relates to the process as described herein, wherein the water comprises minerals selected from the group consisting of sodium hydrogen carbonate, sodium chloride, calcium carbonate, magnesium sulphate, calcium chloride and any combinations thereof.

Reducing the alcohol strength to a concentration of 40% to 54% v/v ethanol leads to aggregation of ethanol in water. During this process, the alcohol molecules form clusters to reduce hydrophobic interactions. The knock-on effect of increased ethanol aggregation in water is that ethyl esters in the system have an increased solubility. An aging process carried out at a higher alcohol strength, (above 60%) leads to increased extraction of ethanol-soluble compounds, such as lactones and a decrease in extraction of colour compounds, tannins and volatile acids. Conversely, an aging process carried out at a lower alcohol strength (below 55%) leads to increased extraction of water-soluble wood components, such as tannins, glycerol and sugars. Thus, it would be advantageous to decrease the alcohol concentration in the beginning of the finishing phase of the present invention in order to enhance the extraction of water-soluble compounds from the wood which are not extracted earlier in the process due to the high alcohol strength during extraction and transformation. An embodiment of the present invention relates to the process as described herein, wherein the alcohol content is decreased to a concentration of 40% to 54% v/v ethanol, such as 42% to 52% v/v, e.g., 44% to 50% v/v, such as 46% to 48% v/v.

An embodiment of the present invention relates to the process as described herein, wherein the finishing phase further comprises a step of removing the wood.

Another embodiment of the present invention relates to the process as described herein, wherein the finishing phase is carried out for 4 to 16 days.

Still, another embodiment of the present invention relates to the process as described herein, wherein the matured spirit comprises one or more maturation congeners selected from the group consisting of gallic acid, furfural, syringic acid, syringaldehyde, vanillin, vanillic acid, eugenol, phenylethyl alcohol, cis-Whisky lactone, benzaldehyde and any combination thereof.

An embodiment of the present invention relates to the process as described herein, wherein the unmatured spirit does not comprise one or more maturation congeners selected from the group consisting of gallic acid, furfural, syringic acid, syringaldehyde, vanillin, vanillic acid, eugenol, phenylethyl alcohol, cis-Whisky lactone, benzaldehyde and any combination thereof.

In the present context, the presence of maturation congeners in the matured spirit is measured by HPLC or GCMS.

A second acid catalyst can be provided in the extraction phase and/or the finishing phase to act as a precursor for esterification and to further increase the presence of aroma compounds in the matured spirit.

Thus, an embodiment of the present invention relates to the process as described herein, wherein the extraction phase and/or the finishing phase further comprise(s) a step of adding a second acid catalyst.

A further embodiment of the present invention relates to the process as described herein, wherein the second acid catalyst is an organic acid. An embodiment of the present invention relates to the process as described herein, wherein the second acid catalyst is selected from the group consisting of citric acid, acetic, lactic, malic, tartaric and any combination thereof. An further of the present invention relates to the process as described herein, wherein the second acid catalyst is citric acid.

An embodiment of the present invention relates to the process as described herein, wherein the concentration of citric acid is in the range from 0.5 mmol/L to 5 mmol/L the extraction phase spirit and/or matured spirit.

An embodiment of the present invention relates to the process as described herein, wherein the concentration of citric acid is in the range from 0.5 mmol/L to 5 mmol/L transformation phase spirit and/or matured spirit.

In some embodiments, an iron compound may be used as an oxidation catalyst to achieve dark colouring of the matured spirit.

An embodiment of the present invention relates to the process as described herein, wherein the transformation phase and/or the finishing phase further comprise(s) a step of providing an iron compound, preferably an iron (III) compound.

A further embodiment of the present invention relates to the process as described herein, wherein the iron compound is selected from the group consisting of ferrous sulfate, black iron oxide, red iron oxide, yellow iron oxide, iron gluconate, ferric ammonium citrate, ferrolactate, ferrohexacyano manganate, ferro carbonate and combinations thereof. In a preferred embodiment the iron compound is ferric ammonium citrate.

Still a further embodiment of the present invention relates to the process as described herein, wherein the iron compound is provided in a concentration ranging from 10 mg/L to 30 mg/L for at least 24 hours.

Yet a further embodiment of the present invention relates to the process as described herein, wherein the iron compound is preferably provided at 50 mg/L for at least 24 hours.

In some embodiments, light can be used to increase the oxidation reaction. UV-light and visible-light exposure can increase the concentration of aldehydes and esters by photooxidation of organic reactions and contribute to dark colouring of the matured spirit.

In the present context, “UV-light” is to be understood as light with a wavelength of 100 nm to 400 nm. In the present context, “visible-light” is to be understood as light with a wavelength of 380 nm to 780 nm. An embodiment of the present invention relates to the process as described herein, wherein the transformation phase and/or the finishing phase further comprise(s) a step of providing light.

In an embodiment, the process comprises a post-processing step, wherein the post-processing step comprises the step of providing light. Preferably, the post-processing step comprises the step of providing UV and/or visible light.

A further embodiment of the present invention relates to the process as described herein, wherein the light is provided at a wavelength spectrum ranging from 100 nm to 780 nm, preferably from 400 nm to 500 nm. In an embodiment the wavelength of the UV light is in the range from 180-280 nm and in another embodiment the wavelength of the visible light is in the range of 380-780 nm.

A further embodiment of the present invention relates to the process as described herein, wherein the light is provided in the range of 10.000 to 30.000 luxhour per liter.

Still a further embodiment of the present invention relates to the process as described herein, wherein the light is preferably provided at 20.000 luxhour per liter.

An embodiment of the present invention relates to the process as described herein, wherein the matured spirit is obtained after 7 days to 21 days from initiation of the extraction phase.

Another aspect of the present invention relates to a product obtained by the process as described herein.

A further aspect of the present invention relates to the use of the product as described herein as a beverage for human consumption.

A still further aspect of the present invention relates to the use of the process for maturing a spirit as described herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “comprises”, “having”, “ranging”, “producing”, “providing”, “provided”, “obtaining” and “obtained” are to be construed as open-ended terms (i.e., meaning “including, but not limited to,”) unless otherwise noted. Recitation of ranges of values herein are merely intended to serve as a shorth and method for referring individually to each separate value falling within the range, unless otherwise indicated herein, and each separate value is incorporated into the specification as if it were individually recited herein. All processes and methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The listing or discussion of an apparently prior published document in this specification should not necessarily be taken as an acknowledgement that the document is part of the state of the art or is common general knowledge. Preferences, options and embodiments for a given aspect, feature or parameter of the invention should, unless the context indicates otherwise, be regarded as having been disclosed in combination with any and all preferences, options and embodiments for all other aspects, features and parameters of the invention.

Embodiments and features of the present invention are also outlined in the following items and also illustrated by the following non-limiting examples.

### Items

1. A process for maturing an unmatured spirit, the process comprising the steps of
   a) an extraction phase,
   b) a transformation phase,
   c) a finishing phase, and
   d) obtaining a matured spirit,
wherein the process is carried out at elevated temperature and with the application of ultrasound;
wherein the extraction phase comprises contacting the unmatured spirit with wood in a reduced oxygen environment;
wherein the transformation phase comprises contacting the unmatured spirit with wood and oxygen;
wherein the finishing phase comprises contacting the unmatured spirit with oxygen and optionally wood; and
wherein the process is carried out for 21 days or fewer.
2. A process for maturing an unmatured spirit, the process comprising the steps of
   a) an extraction phase,
   b) a transformation phase,
   c) a finishing phase, and
   d) obtaining a matured spirit,
wherein the extraction phase, transformation phase and finishing phase are carried out at elevated temperature and with the application of ultrasound;
wherein the extraction phase comprises contacting the unmatured spirit with wood in a reduced oxygen environment;
wherein the transformation phase comprises contacting the unmatured spirit with wood and oxygen;
wherein the finishing phase comprises contacting the unmatured spirit with oxygen and optionally wood; and
wherein the process is carried out for 21 days or fewer.
3. A process for maturing an unmatured spirit, the process comprising the steps of
   a) an extraction phase,
   b) a transformation phase,
   c) a finishing phase, and
   d) obtaining a matured spirit,
wherein the process is carried out at elevated temperature and with the application of ultrasound;

wherein the extraction phase comprises contacting the unmatured spirit with wood in a reduced oxygen environment;

wherein the transformation phase comprises contacting the unmatured spirit with wood and oxygen;

wherein the finishing phase comprises contacting the unmatured spirit with oxygen and optionally wood,
wherein the process is carried out for 21 days or fewer; and
wherein the process comprises diluting an extraction phase, transformation phase and/or finishing phase spirit, wherein the extraction phase, transformation phase and/or finishing phase spirit is in contact with wood during said dilution.
4. The process according to any one of the preceding items, wherein the unmatured spirit is selected from the group consisting of sugar cane spirits, grain spirits, malt spirit, potato spirit, fruit spirits, agave spirits and any combination thereof.
5. The process according to any one of the preceding items, wherein the unmatured spirit is selected from the group consisting of rum, tequila, mescal, whiskey, whiskey, vodka, eau de vie, aquavit, sherry, bierbrand, beer, wine brandy, gin, sake, soju, baidju and any combination thereof.
6. The process according to any one of the preceding items, wherein the unmatured spirit has an ethanol content of 60 to 65% v/v.
7. The process according to any one of the preceding items, wherein the elevated temperature is from 50° C. to 75° C.
8. The process according to any one of the preceding items, wherein the preferred elevated temperature is 65° C.
9. The process according to any one of the preceding items, wherein the ultrasound is applied at a frequency greater than 20.000 kHz.
10. The process according to any one of the preceding items, wherein the ultrasound is applied at a power of at least 1 Watt/liter.
11. The process according to any one of the preceding items, wherein the ultrasound is applied at a power between 2 to 5 Watts/liter.
12. The process according to any one of the preceding items, wherein the ultrasound is applied in cycles.
13. The process according to any one of the preceding items, wherein the ultrasound is applied in cycles of 8 to 12 hours for at least 8 days.
14. The process according to any one of the preceding items, wherein the ultrasound is applied using a cascatrode.
15. The process according to any one of the preceding items, wherein the extraction phase is terminated when the colour of the extraction phase spirit is measured on the European Brewing Convention (EBC) scale in the range of 2 to 8 EBC and/or when 4 days have elapsed from initiation of the extraction phase.
16. The process according to any one of the preceding items, wherein the extraction phase comprises a step of providing a first acid catalyst.
17. The process according to any one of the preceding items, wherein the first acid catalyst is an inorganic acids and/or an organic acid.
18. The process according to any one of the preceding items, wherein the first acid catalyst is selected from the group consisting of hydrochloric acid, citric acid, acetic acid, malic acid, tartaric acid and any combinations thereof.
19. The process according to any one of the preceding items, wherein the first acid catalyst is hydrochloric acid.
20. The process according to any one of the preceding items, wherein the concentration of hydrochloric acid is in the range of 0.02 mMol/liter to 0.2 mMol/liter in the extraction phase spirit and/or matured spirit.
21. The process according to any one of the preceding items, wherein the transformation phase further comprises a step of adding wood.
22. The process according to any one of the preceding items, wherein the oxygen is provided at 0.01 to 0.1 L per minute per liter of transformation phase spirit for at least 5 hours.
23. The process according to any one of the preceding items, wherein the oxygen is preferably provided at 0.01 L per minute per liter of transformation phase spirit for at least 5 hours.
24. The process according to any one of the preceding items, wherein the oxygen is provided in cycles.
24. The process according to any one of the preceding items, wherein the oxygen is provided in at least 5 cycles.
25. The process according to any one of the preceding items, wherein a constant circulating flow rate is provided.
26. The process according to any one of the preceding items, wherein the circulating flow rate is provided in the range between 1 to 15 mm/s.
27. The process according to any one of the preceding items, wherein the preferred circulating flow rate is 2 mm/s.
28. The process according to any one of the preceding items, wherein the circulating flow rate is provided in the range between 1 to 60 rpm.
29. The process according to any one of the preceding items, wherein the transformation phase is terminated when the colour of the transformation phase spirit is measured on the European Brewing Convention (EBC) scale in the range of 4 to 12 EBC and/or after 5 days from the initiation of the transformation phase spirit.
30. The process according to any one of the preceding items, wherein the wood is selected from the group consisting of oak, cedar, birch, beech, acacia, maple, hickory, redwood, walnut, chestnut, apple, pecan, cherry, plum and any combinations thereof.
32. The process according to any one of the preceding items, wherein the wood is new wood and/or re-used wood from spirits, wine or beer barrels.
33. The process according to any one of the preceding items, wherein the wood is cube or cylinder shaped.
34. The process according to any one of the preceding items, wherein the wood is in pieces and the pieces have at least one dimension that is 2 cm or less.
35. The process according to any one of the preceding items, wherein the wood has a surface area of 10 to 30 cm².
36. The process according to any one of the preceding items, wherein the wood has a preferred surface area of 16 cm².
37. The process according to any one of the preceding items, wherein the wood is pre-treated.
38. The process according to any one of the preceding items, wherein the pre-treatment comprises a first step of soaking the wood in water, wine, spirits and combinations thereof.
39. The process according to any one of the preceding items, wherein the pre-treatment further comprises a step of soaking the wood in water comprising enzymes sugars, acids, tannins, polyphenols and combinations thereof.
40. The process according to any one of the preceding items, wherein the pre-treatment comprises a final step of toasting, charring, polishing, sanding and combinations thereof.
41. The process according to any one of the preceding items, wherein the wood to spirit ratio in g/L in the extraction phase and transformation phase is between 2 to 20 g/L.
42. The process according to any one of the preceding items, wherein the preferred wood to spirit ratio in g/L in the extraction phase and transformation phase is 5 g/L.
43. The process according to any one of the preceding items, wherein the finishing phase comprises providing oxygen to the transformation phase spirit.
44. The process according to any one of the preceding items, wherein the finishing phase further comprises a step of decreasing the alcohol content by adding water.
45. The process according to any one of the preceding items wherein the water is reverse osmosis water.
46. The process according to any one of the preceding items, wherein the water comprises minerals selected from the group consisting of sodium hydrogen carbonate, sodium chloride, calcium carbonate, magnesium sulphate, calcium chloride and any combinations thereof.
47. The process according to any one of the preceding items wherein the alcohol content is decreased to a concentration of 40% to 54% v/v ethanol.
48. The process according to any one of the preceding items, wherein the finishing phase further comprises a step of removing the wood.
49. The process according to any one of the preceding items, wherein the finishing phase is carried out for 4 to 16 days.
50. The process according to any one of the preceding items, wherein the matured spirit comprises one or more maturation congeners selected from the group consisting of gallic acid, furfural, syringic acid, syringaldehyde, vanillin, vanillic acid, eugenol, phenylethyl alcohol, cis-Whisky lactone, benzaldehyde and any combination thereof.
51. The process according to any one of the preceding items, wherein the unmatured spirit does not comprise one or more maturation congeners selected from the group consisting of gallic acid, furfural, syringic acid, syringaldehyde, vanillin, vanillic acid, eugenol, phenylethyl alcohol, cis-Whisky lactone, benzaldehyde and any combination thereof.
52. The process according to any one of the preceding items, wherein the extraction phase and/or the finishing phase further comprise(s) a step of adding a second acid catalyst.
53. The process according to any one of the preceding items, wherein the second acid catalyst is an organic acid.
54. The process according to any one of the preceding items, wherein the second acid catalyst is selected from the group consisting of citric acid, acetic, lactic, malic, tartaric and any combination thereof.
55. The process according to any one of the preceding items, wherein the second acid catalyst is citric acid.
56. The process according to any one of the preceding items, wherein the concentration of citric acid is in the range of 0.5 mmol/L to 5 mmol/L in the extraction phase spirit and/or matured spirit.
57. The process according to any one of the preceding items, wherein the concentration of citric acid is in the range of 0.5 mmol/L to 5 mmol/L transformation phase spirit and/or matured spirit.
58. The process according to any one of the preceding items, wherein the transformation phase and/or the finishing phase further comprise(s) a step of providing an iron compound.
59. The process according to any one of the preceding items, wherein the iron compound is selected from the group consisting of ferrous sulfate, black iron oxide, red iron oxide, yellow iron oxide, iron gluconate, ferric ammonium citrate, ferrolactate, ferrohexacyano manganate, ferro carbonate and combinations thereof.
60. The process according to any one of the preceding items, wherein the iron compound is provided in a concentration ranging from 10 mg/L to 30 mg/L for at least 24 hours.
61. The process according to any one of the preceding items, wherein the iron compound is preferably provided at 50 mg/L for at least 24 hours.
62. The process according to any one of the preceding items, wherein the transformation phase and/or the finishing phase further comprise(s) a step of providing light.
63. The process according to any one of the preceding items, wherein the light is provided at a wavelength spectrum ranging from 100 nm to 780 nm, preferably from 400 nm to 500 nm.
64. The process according to any one of the preceding items, wherein the light is provided in the range of 10.000 to 30.000 luxhour per liter.
65. The process according to any one of the preceding items, wherein the light is preferably provided at 20.000 luxhour per liter.
66. The process according to any one of the preceding items, wherein the matured spirit is obtained after 7 days to 21 days from initiation of the extraction phase.
67. The process according to any preceding items comprising a dilution step.
68. The process according to preceding item, wherein the process comprises diluting a spirit, and wherein said spirit is in contact with wood.
69. The process according to any preceding items, wherein at least one of the extraction phase, transformation phase and finishing phase comprises a dilution step.
70. The process according to any preceding items wherein a dilution step is carried out part-way through the extraction phase, transformation phase or finishing.
71. The process according to any preceding items, comprising a dilution of the extraction phase spirit and wherein the extraction phase spirit is in contact with wood.
72. The process according to any preceding items, comprising a dilution of the transformation phase spirit and wherein the transformation phase spirit is in contact with wood.
73. The process according to any preceding items, comprising a dilution of the finishing phase spirit and wherein the finishing phase spirit is in contact with wood and before the finishing phase is terminated.
74. The process according to any preceding items wherein the diluted extraction phase spirit, transformation phase spirit and/or finishing phase spirit has an ethanol content of 35-65% v/v, such as 40-60% v/v, such as 45-60% v/v, e.g. 45-55% v/V, preferably 48-55% v/v and more preferably 50-53% v/V.
75. The process according to any preceding items wherein the diluted extraction phase spirit, transformation phase spirit and/or finishing phase spirit has an ethanol content of 42-52% v/v, e.g., 44-50% v/v, such as 46-48% v/v after dilution.
76. The process according to any preceding item wherein the dilution step comprises adding 1-10% v/v water, such as 1-5% v/v water, 1-3% v/v water, preferably 2% v/v water.
77. The process according to any preceding item wherein the dilution step comprises adding 1-10% v/v water, waiting at least 2 hours, and adding more water.
78. The process according to any preceding item wherein the dilution step comprises a delay of 2-96 hours between additions of water, for instance, a delay 2-72 hours, 2-48 hours, 2-24 hours or 2-12 hours between additions of water and waiting at least 5 minutes before the addition of more water.
79. The process according to any preceding item wherein the dilution step comprises adding 2% v/v water, waiting at least 2 hours and adding a further 2% v/v water.
80. The process according to any preceding item wherein the dilution step comprises multiple additions of water wherein each addition comprises adding 1-10% v/v water, such as 1-5% v/v water, 1-3% v/v water, preferably 2% v/v water.
81. The process according to any preceding items comprising more than one dilution step.
82. The process according to any preceding item comprising multiple dilution steps, wherein the dilution steps are carried out on the same spirit phase.
83. The process according to any preceding item comprising multiple dilution steps, wherein the dilution steps are carried out on different spirit phases.
82. The process according to any preceding items comprising a post-processing step carried out on the matured spirit.
83. The process according to any preceding items wherein the post-processing step comprises providing light, and wherein light is selected from UV or visible light.
84. The process according to any preceding items wherein the wavelength of the UV light is in the range from 180-280 nm.
85. The process according to any preceding items wherein the wavelength of the visible light is in the range of 380-780 nm.
85. The process according to any preceding items wherein the post-processing step comprises providing a first acid catalyst, and wherein the first acid catalyst is an organic or inorganic catalyst.
87. The process according to any preceding items wherein the post-processing step is carried out at a temperature of 35-55° C., for instance 36-52° C., preferably 39-49° C.
88. A product obtained by the process according to any one of the preceding items.
89. Use of the product according to item 76 as a beverage for human consumption.
90. Use of the process of any one of item 1-75 for maturing a spirit.

### EXAMPLES

### Example 1

### Wood Pre-Treatment

Wood is prepared as the first step. An oak barrel is disassembled into individual staves. A stave is cut into cubes wherein the diagonal diameter (corner to corner) of the cube face is less than 2 cm.

The cubes are then cleaned of impurities if needed by sanding technique. Next, the cubes can be either:
a) charred for 1 to 2 min in the open flame and immediately soaked in water for at least two hours, or
b) toasted in the oven at 160-200° C. for 90 to 120 minutes and then immediately soaked in water for at least two hours.

### Process Preparation

200 litres of the unprocessed unmatured spirit is transferred to the reactor's tank, while the pre-treated wood cubes are placed in the casket with a filter.

### Extraction Phase

The system is closed and programmed to a controlled temperature in a range from 60° C. to 70° C., and a flow rate between 50 to 60 rpm. Ultrasound is applied at 20.000 kHz with an amplitude in the range of 15 to 90 micrometres for the first 48 hours. If needed, hydrochloric acid can be introduced at this step as a catalyst in the range of 0.02 mMol/liter to 0.2 mMol/liter.

### Transformation Phase

The extraction phase spirit is sampled in order to establish if sufficient extraction was achieved. Sufficient extraction is achieved once the colour of the extraction phase spirit in the range of 2 to 8 EBC (when measured on the European Brewing Convention (EBC) scale) and/or when 4 days have elapsed from initiation of the extraction phase. When enough wood extraction is established then oxygen is provided at 0.01-0.1 L per minute per litre of transformation phase spirit for at least 5 hours. The transformation phase is run at temperature in a range from 60° C. to 70° C. Ultrasound is applied at 20.000 kHz with an amplitude in the range of 15 to 90 micrometres. The transformation phase is terminated when the colour of the transformation phase spirit is in the range of 4 to 12 EBC and/or after 5 days from the initiation of the transformation phase.

### Finishing Phase

During the last days of production, the transformation phase spirit is diluted with reverse osmosis water. Wood cubes are still left in the tank in order to extract more water-soluble extractives from the matrix, the dilution is carried out by adding a maximum of 4 litres of water at a time (2% v/v water), until the strength of 50 to 54 alcohol by volume. Organic acids can be added at this point to influence the ethanol/water partition coefficient and achieve certain flavour profiles. The colour of the spirit can be adjusted by either oak char filtration which acts as activated carbon or by the addition of iron compound in the range of 10 ppm to 100 ppm.

### Obtaining a Matured Spirit

In the last step, the matured spirit is diluted to the final desired alcohol strength and filtered prior to bottling.

### Example 2—Ultrasound

Comparative tests were carried out to demonstrate the effect of ultrasound on the process of the invention.

A finishing phase was carried out with and without the application of ultrasound (Hierscher UP400st sonicator, which corresponds to 1000 Ws/ml). For both samples, the finishing phase was carried out at 65° C. at an ethanol content of 63.5% v/v.

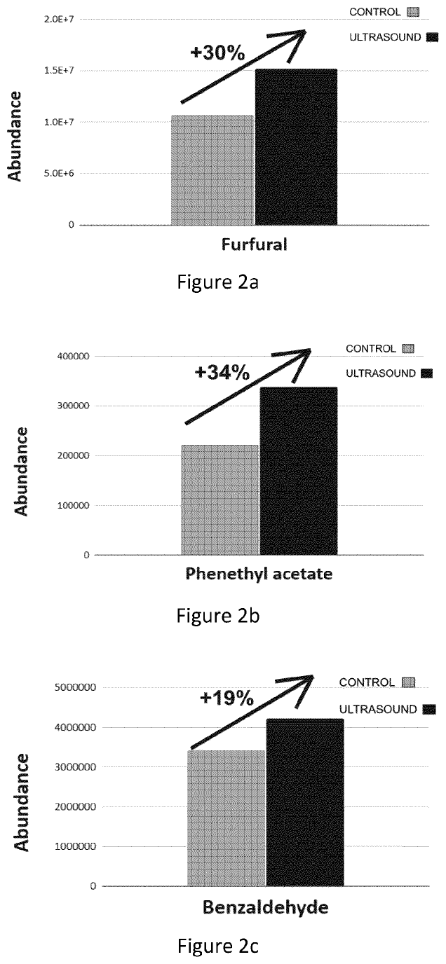

FIGS. 2a-2c show that the application of ultrasound can increase the abundance of flavour compounds (i.e. maturation congeners) such as furfural, phenethyl acetate and benzaldehyde, all of which are associated with a mature flavour.

### Example 3—Dilution

Comparative tests were carried out to demonstrate the effect of a process comprising diluting a spirit, and wherein said spirit is in contact with wood.

Two identical finishing phase spirits in contact with wood were provided by the method of the present invention (Beta 1: 62 ABV and Beta 2: 52 ABV). The ethanol content of Beta 1 was 62 ABV whereas Beta 2 was diluted with reverse osmoses water whilst still in contact with wood, and the abundance of different flavour compounds (maturation congeners) was assessed for both Beta 1 and Beta 2. For both samples, the finishing phase was carried out at 60° C. with the application of ultrasound (Hielscher UIP1000 hdT (1000 W,20 kHz) ultrasound system, which corresponds to around 240 J/ml for the entire process).

The abundance of flavour compounds (maturation congeners) was determined via GC-MS and the % change in abundance calculated for extraction in Beta 1 and Beta 2 Any suitable method can be used to determine the abundance of flavour compounds (maturation congeners).

FIGS. 3a and 3b show that ethyl octanoate and cis-whisky lactone are extracted more efficiently in Beta 1 than in Beta 2.

FIGS. 3c and 3b show that vanillin and syringaldehyde are extracted more efficiently at Beta 2 than in Beta 1.

Typically, a high concentration of vanillin, syringealdehyde, furfural and phenethyl acetate is desirable. Conversely, a low concentration of certain medium/long-chain ester such as ethyl octanoate is desired.

Typically, ethyl octanoate (similarly to ethyl decanoate) is associated with an immature flavour profile and therefore it is preferable to minimize its extraction, or to trap it in the water phase such that volatility into the headspace is prevented.

Performing a dilution step whilst a spirit in contact with wood can reduce the extraction of such compounds.

Conversely, cis-whisky lactone, vanillin and syringaldehyde all of which are maturation congeners are associated with a mature flavour profile and it may be preferable to enhance their extraction. Again, performing a dilution step on a spirit in contact with wood is shown to provide such an effect.

If the process of the disclosure process is carried out at only one ethanol content (or ABV), it is difficult to tailor the balance of mature and immature flavour components to provide a customized flavour profile. The flavour profile can therefore be tailored and improved by including a dilution step, or steps, in the process in order to control the extraction of wanted and unwanted compounds.

### Example 4—UV and Visible Light

Comparative tests were carried out to demonstrate the effect of a UV or visible light.

After obtaining a mature spirit, samples were irradiated with either UV light or visible light in a post-processing step and compared to a control sample and the relative abundance of flavour compounds was determined via GC-MS.

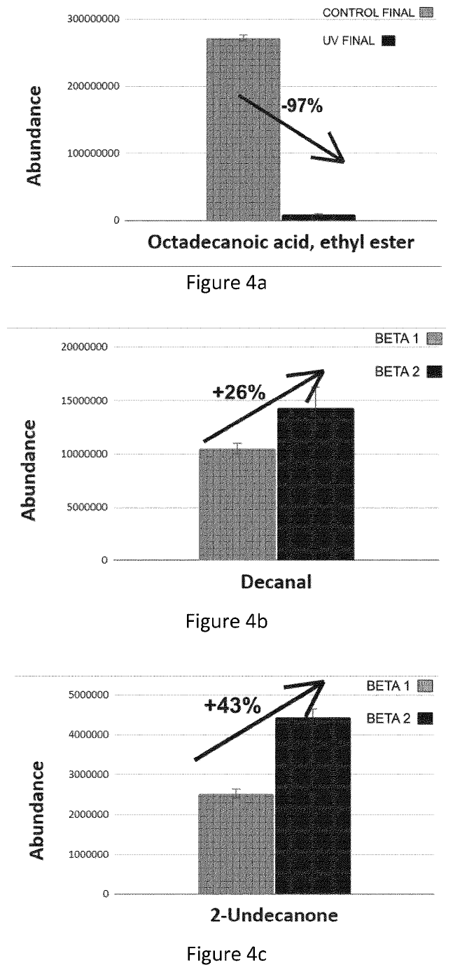

FIG. 4a shows that the average abundance of octadecanoic acid, ethyl ester was reduced by −97% by UV light treatment, when the UV light wavelength is from 180-280 nm. Irradiation with UV light resulted in a slight temperature increase from room temperature, and the sample reached a temperature of around 39° C. during UV light post-processing.

A similar pattern is observed with other long-chain esters, for instance, undecanoic acid, 10-methyl-, methyl ester exhibited an 84% decrease, while dodecanoic acid, ethyl ester showed a 56% reduction when compared to a control sample.

It is thought that irradiation with UV light triggers photooxidative degradation of long-chain esters, resulting in a reduced abundance. Irradiation with UV light, for example in post-processing, is therefore beneficial for obtaining matured spirits with a low long-chain ester concentration.

FIGS. 4b and 4c shows that the average abundance of decanal (an aldehyde) and 2-udecanone (a ketone) is increased by irradiation with visible light (Lumatek CMH Lamp 315 W 3100/4200K 240V, 380 nm-780 nm).

Irradiation with visible light resulted in a slight temperature increase from room temperature, and the sample reached a temperature of around 49° C. during visible light post-processing.

Exposure to visible light resulted in a 26% increase in the abundance of the aldehyde compared to the average values obtained from three separate runs. Exposure to visible light resulted in a 43% increase in the abundance of the ketone compared to the average values obtained from three separate runs. It is considered that this occurs due to the photodegradation of larger compounds.

Accordingly, irradiation with visible light, even in post-processing, is therefore beneficial for obtaining matured spirits with a high aldehyde or ketone concentration, which improves the sensory experience.

### Example 5—Acid

Testing was carried out to demonstrate the effect of adding a first acid catalyst.

Six samples were prepared, three to test the effect of an organic acid (samples 1-3) and three to test the effect of an inorganic acid (samples 4-6), wherein in each case, the acid was added to a mature spirit in a post-processing step.

For each acid type, a control and two different concentrations of acid were tested. The effect on the abundance of flavour compounds was assessed using GC-MS. Results are shown in Table 1 below.

TABLE 1

| | | Acid | | Flavour | % change in |
|---|---|---|---|---|---|
| Sample | Acid | conc | | compound // conc | abundance |
| 1 | Acetic | 1 | g/L | Ethyl acetate // | 31% vs sample 3 |
| | | | | 117 mg/L | |
| 2 | Acetic | 0.33 | g/L | Ethyl acetate // | 25% increase vs |
| | | | | 111 mg/L | sample 3 |
| 3 | — | — | | Ethyl acetate // | — |
| | | | | 89 mg/L | |
| 4 | Hydrochloric | 1 | g/L | Ethyl decanoate // | 27% vs sample 6 |
| | | | | 14 mg/L | |
| 5 | Hydrochloric | 0.33 | g/L | Ethyl decanoate // | 18% vs sample 6 |
| | | | | 13 mg/L | |

| | | | | |
|---|---|---|---|---|
| 6 | — | — | Ethyl decanoate // | — |

11 mg/L

Table 1 demonstrates that an organic acid post-processing step increases the abundance of ethyl acetate, and an inorganic post-processing step increases the abundance of ethyl decanoate, due to catalysation of the esterification reaction. In both cases, the increase is around 30% when a concentration of 1 g/L acid is used, and between 18-25% when 0.33 g/L acid is used.

Due to the complexity of flavour in matured spirits, small changes in the concentration of flavour compounds can have a remarkable effect on the consumer's sensory experience.

Table 1 shows that including a first acid catalyst in the process, such as performing an acid post-processing step, may be used to achieve said small changes.

### Summary of Examples

As the examples show, the abundance of flavour compounds (maturation congers) is affected by a number of different process and/or post-processing parameters, and what's more, not all compounds are affected in the same was for all parameters.

Accordingly, the process and/or post-processing parameters can advantageously be selected in order to arrive at a mature spirit with the desired flavour profile.

In an example, a process comprising a dilution step such that extraction from wood occurs at a high ethanol content may result in overextraction of compounds such as ethyl decanoate (see example 3). In this instance, over-extraction may be countered in-situ by including an acid in one of the process steps (thus changing the partition coefficient and removing ethyl deconaoate from the headspace).

In the opposite case, a process comprising a dilution step such that extraction from wood occurs at a low ethanol content may result in under-extraction of compounds such as ethyl decanoate. A post-processing step comprising providing a first acid (see example 5) can be utilized to catalyse an esterification reaction and increase its abundance in the final product.

Alternatively, in some embodiments, the abundance of ethyl decanoate in the final product may be controlled by carefully selecting the timing and the degree of dilution carried out whilst the spirit is in contact with wood.

1. A process for maturing an unmatured spirit, the process comprising:
a) an extraction phase,
b) a transformation phase,
c) a finishing phase, and
d) obtaining a matured spirit,
wherein the process is carried out at elevated temperature and with the application of ultrasound;
wherein the extraction phase comprises contacting the unmatured spirit with wood in a reduced oxygen environment;
wherein the transformation phase comprises contacting the unmatured spirit with wood and oxygen;
wherein the finishing phase comprises contacting the unmatured spirit with oxygen and optionally wood,
wherein the process is carried out for 21 days or fewer; and
wherein the process comprises diluting an extraction phase, transformation phase and/or finishing phase spirit, wherein the extraction phase, transformation phase and/or finishing phase spirit is in contact with wood during said dilution.

2-11. (canceled)

12. The process according to claim 1, wherein the elevated temperature is from 50° C. to 75° C.

13. The process according to claim 1, wherein the extraction phase is terminated when the colour of the extraction phase spirit is measured on the European Brewing Convention (EBC) scale in the range of 2 to 8 EBC and/or when 4 days have elapsed from initiation of the extraction phase.

14. The process according to claim 1, wherein the extraction phase comprises a step of providing a first acid catalyst selected from the group consisting of hydrochloric acid, citric acid, acetic acid, malic acid, tartaric acid and any combinations thereof.

15. The process according to claim 1, wherein the transformation phase is terminated when the colour of the transformation phase spirit is measured on the European Brewing Convention (EBC) scale in the range of 4 to 12 EBC and/or after 5 days from the initiation of the transformation phase.

16. The process according to claim 1, wherein the wood is in pieces and the pieces have at least one dimension that is 2 cm or less.

17. The process according to claim 1, wherein the wood to spirit ratio in g/L in the extraction phase and transformation phase is between 2 to 20 g/L.

18. The process according to claim 1, wherein the finishing phase further comprises a step of decreasing the alcohol content by adding water.

19. The process according to claim 1, wherein the finishing phase is carried out for 4 to 16 days.

20. The process according to claim 1, wherein the unmatured spirit does not comprise one or more maturation congeners selected from the group consisting of gallic acid, furfural, syringic acid, syringaldehyde, vanillin, vanillic acid, eugenol, phenylethyl alcohol, cis-Whisky lactone, benzaldehyde and any combination thereof.

21. A process for maturing an unmatured spirit, the process comprising:
e) an extraction phase,
f) a transformation phase,
g) a finishing phase, and
h) obtaining a matured spirit,
wherein the process is carried out at elevated temperature and with the application of ultrasound;
wherein the extraction phase comprises contacting the unmatured spirit with wood in a reduced oxygen environment;
wherein the transformation phase comprises contacting the unmatured spirit with wood and oxygen;
wherein the finishing phase comprises contacting the unmatured spirit with oxygen and optionally wood; and
wherein the process is carried out for 21 days or fewer.
